(19) United States
(12) Patent Application Publication
(10) Pub. No.: US 2007/0053506 A1
(43) Pub. Date: Mar. 8, 2007

(54) Elliptic curve encryption processor, processing method of the processor using elliptic curves, and program for causing a computer to execute point scalar multiplication on elliptic curves

(76) Inventor: Katsuyuki Takashima, Tokyo (JP)

Correspondence Address: BIRCH STEWART KOLASCH & BIRCH, PO BOX 747, FALLS CHURCH, VA, 22040-0747, US

(21) Appl. No.: 10/572,500

(22) PCT Filed: Sep. 15, 2004
(86) PCT No.: PCT/JP04/13409

§ 371 Date: Mar. 17, 2006

(51) Int. Cl. H04L 9/28

(52) U.S. Cl. 380/28

(57) ABSTRACT

An object is to make a conventional GLV scalar multiplication applicable to a wider range of elliptic curves. An elliptic curve encryption processor includes an input section 2 that inputs information indicating an elliptic curve E, a point P on the elliptic curve, and an operation value K; an embedding operation section 3 that maps the point P on the elliptic curve E to a Jacobi variety of an algebraic curve corresponding to the elliptic curve E, thereby obtaining a point on the Jacobi variety of the algebraic curve corresponding to the elliptic curve E as an embedding point D; a homomorphic processing section 4 that performs a mapping by a homomorphism on the Jacobi variety of the algebraic curve, thereby obtaining a mapping point εD; a projection operation section 5 that performs a mapping to the elliptic curve E, thereby obtaining a projection point P′ on the elliptic curve; and a computing section 6 that performs a computation using the operation value K and the projection point P′.

### TECHNICAL FIELD

The present invention relates to an elliptic curve encryption processor that performs an operation of scalar multiplication of elliptic curve cryptography, a method for performing the operation of scalar multiplication on elliptic curve cryptography by the elliptic curve encryption processor, and a program for causing a computer to execute the operation of scalar multiplication on elliptic curve cryptography.

### BACKGROUND ART

For high-speed encryption processing of elliptic curve cryptography, the operation of scalar multiplication needs to be speeded up since the operation is performed with high frequency in elliptic curve cryptography. There are various methods of high-speed scalar multiplication that have been proposed. Recent research has developed a method of speeding up scalar multiplication (See Non-Patent Document 1). Specifically, this method of speeding up scalar multiplication uses a special homomorphism φ, which is an efficiently computable endomorphism, and describes a scalar multiple K as K=k₁+k₂φ(or k₁+k₂λ, where λ is a scalar multiple given by (p on a point group). This method speeds up scalar multiplication by dividing the scalar multiplication by the scalar multiple K into a scalar multiplication by k₁ and a scalar multiplication by k₂. The scalar multiplication thus speeded up by using the special homomorphism is called GLV scalar multiplication, which is named after the initials of the person who proposed the method.

A non-patent document 2 describes a result of an expanded application of the above method performed on hyperelliptic curves (See Non-Patent Document 2).

A non-patent document 4 describes a homomorphism between a product E×E of an elliptic curve E and a Jacobi variety of a hyperelliptic curve C of genus 2 (See Non-Patent Document 4).

[Non-Patent Document 1] R. P. Gallant, J. L. Lambert and S. A. Vanstone, Faster point multiplication on elliptic curves with efficient endomorphisms”, Crypto 2001, Springer Verlag, (2001), 190-200.

[Non-Patent Document 2] F. Sica, M. Ciet, J. -J. Quisquater, “Analysis of the Gallant-Lambert-Vanstone method based on efficient endomorphisms: elliptic and hyperelliptic curves”, SAC 2002,Springer Verlag, (2002), 21-36.

[Non-Patent Document 3] M. Ciet, T. Lange, F. Sica, J. -J. Quisquater, “Improved Algorithms for Efficient Arithmetic on Elliptic Curves using Fast Endomorphisms”, EUROCRYPT 2003,Springer Verlag, (2003), 388-400.

[Non-Patent Document 4] P. R. Bending, “Curves of genus 2 with √2 Multiplication”, http://www.math.uiuc.edu/Algebraic-Number-Theory/

### DISCLOSURE OF THE INVENTION

### PROBLEMS TO BE SOLVED BY THE INVENTION

With the practical use of advanced information and communications technologies in recent years, public key cryptography including elliptic curve cryptography has already been in a practical stage as well. For that reason, encryption processing on an IC card is becoming indispensable if the IC card is only equipped with the Central Processing Unit (CPU) whose clock frequency is low, or the IC card is not capable of having a CPU. The use of elliptic curve cryptography in an environment with limited computing resources is also becoming essential in order to ensure information security in a ubiquitous environment. As a result, there is a strong desire to speed up the processing of elliptic curve cryptography.

However, the application of the conventional GLV scalar multiplication is limited to special types of elliptic curves. Currently, it is a common practice that elliptic curves are selected at random for use in elliptic curve cryptography. And this practice gives the guaranteed security of elliptic curve cryptography. Certainly, it is possible to speed up encryption processing with elliptic curves by using the GLV scalar multiplication. However, a security problem lies in that elliptic curves cannot be selected at random. The problem has been posed when the encryption processing is executed on an IC card or used in a ubiquitous environment.

Given that fact, an object is to make the conventional GLV scalar multiplication applicable to a wider range of elliptic curves.

### PROBLEMS TO SOLVE THE PROBLEMS

An elliptic curve encryption processor includes: an input section that inputs information indicating an elliptic curve E, a point P on the elliptic curve E, and an operation value K, and stores the information, the point P, and the operation value K in a memory section; an embedding operation section that retrieves the point P on the elliptic curve E stored in the memory section, maps the point P on the elliptic curve E to a Jacobi variety of an algebraic curve corresponding to the elliptic curve E, thereby obtaining a point on the Jacobi variety of the algebraic curve corresponding to the point P on the elliptic curve E as an embedding point D, and stores the embedding point D in the memory section; a homomorphic processing section that retrieves the embedding point D stored in the memory section, maps the embedding point D using a homomorphism on the Jacobi variety of the algebraic curve, thereby obtaining a mapping point εD, and stores the mapping point ED in the memory section; a projection operation section that retrieves the mapping point εD stored in the memory section, maps the mapping point ED onto the elliptic curve E, thereby obtaining a projection point P′ on the elliptic curve, and stores the projection point P′ in the memory section; and a computing section that retrieves the operation value K and the projection point P′ that are stored in the memory section, performs a computation using the operation value K and the projection point P′, and stores a computation result in the memory section.

### EFFECT OF THE INVENTION

The elliptic curve encryption processor may include: an input section that inputs information indicating an elliptic curve E, a point P on the elliptic curve E, and an operation value K, and stores the information, the point P, and the operation value K in a memory section; an embedding operation section that retrieves the point P on the elliptic curve E stored in the memory section, maps the point P on the elliptic curve E to a Jacobi variety of an algebraic curve corresponding to the elliptic curve E, thereby obtaining a point on the Jacobi variety of the algebraic curve corresponding to the point P on the elliptic curve E as an embedding point D, and stores the embedding point D in the memory section; a homomorphic processing section that retrieves the embedding point D stored in the memory section, maps the embedding point D using a homomorphism on the Jacobi variety of the algebraic curve, thereby obtaining a mapping point εD, and stores the mapping point εD in the memory section; a projection operation section that retrieves the mapping point εD stored in the memory section, maps the mapping point εD onto the elliptic curve E, thereby obtaining a projection point P′ on the elliptic curve, and stores the projection point P′ in the memory section; and a computing section that retrieves the operation value K and the projection point P′ that are stored in the memory section, performs a computation using the operation value K and the projection point P′, and stores a computation result in the memory section.

### BEST MODE FOR CARRYING OUT THE INVENTION

A description will be given here of an embodiment for faster scalar multiplication performed by an elliptic curve encryption processor. In this embodiment, a hyperelliptic curve C of genus 2 is used as an algebraic curve, and √2 multiplication, which is an efficiently computable homomorphism, is used as a homomorphism.

A brief description will be given first of public key cryptography, discrete logarithmic problem, elliptic curve cryptography, and hyperelliptic curve cryptography.

In communications using public key cryptography, a set of a private key x and a public key y is provided for each user. Each user keeps the private key x of himself/herself secret while the public key of himself/herself is opened to the public other than himself/herself. When a user B intends to transmit data confidentially to a user A, a user B encrypts the data using the public key y of the user A. The user A decrypts encrypted data using the private key x that is known only by the user A. This ciphertext cannot be decrypted by anyone but the user A who is the only person knows the private key x.

The discrete logarithm problem is a problem of finding m that satisfies g₁=mg₂ for two elements g₁, g₂ of an algebraic group G (addition is assumed to be defined). It is known to be very difficult to solve many discrete logarithmic problems in terms of the amount of computation if the number of elements of the algebraic group G is large. This fact may be exploited in designing public key cryptography.

There are many types of discrete-logarithm-based public-key cryptography, in which an expression for defining the algebraic group G and g₂ are public key cipher parameters, g₁ is the public key, and m is the private key.

A hyperelliptic curve C of genus g over a finite field GF(qⁿ) (q is a power of a prime number p) is an equation that is expressed as y²+h(x)y=f(x) (where h(x), f(x) are a g- or lower-degree polynomial and a degree 2g+1 polynomial, respectively, of a GF(qⁿ) coefficient and a leading coefficient of f(x) is 1). Then, a rational point set of a Jacobi variety (Jacobian) of a hyperelliptic curve C has a definition of addition and becomes a group. Specifically, the hyperelliptic curve when the genus g is 1 is called an elliptic curve, which has the definition of addition itself. The public key cryptography that uses these groups is called hyperelliptic curve cryptography (when g=1, then it is called elliptic curve cryptography).

More specifically, with the elliptic curve cryptography, the coefficients of the equation y²+h(x)y=f(x) and a point (x0, y0) on the elliptic curve become elliptic curve cryptography parameters. Then, (x1,y1) ((x1,y1) satisfies (x1,y1)=m·(x0,y0)), which is computed according to the addition on the elliptic curve, becomes the public key, and m becomes the private key.

With the hyperelliptic curve cryptography of genus g, the coefficients of the equation y²+h(x)y=f(x) is part of the cipher parameter, which is the same. In addition to that, however, a point on the Jacobian of that curve (a divisor class on that curve) D1 is needed as another cipher parameter. Then, D2 (D2 satisfies D2=m·D1), which is computed according to the addition on the Jacobian, becomes the public key, and m becomes the private key.

In a scalar multiplication K·(x0, y0) of the point (x0, y0) on the elliptic curve by a scalar multiple K, it takes a lot of time for computation if the value of the scalar multiple K is large. With elliptic curve cryptography, for example, a binary 160-bit value is used as the scalar multiple K. In this case, if a bit value in each digit of the 160 bits is added one by one to the elliptic curve cipher parameter, a tremendous amount of time is required.

With the GLV scalar multiplication, the scalar multiple K is expressed as K=k₁+k₂φ (or k₁+k₂λ, where λ is a scalar multiple given by φ on a point group). Therefore, the scalar multiplication by the scalar multiple K is divided into a scalar multiplication by k₁ and a scalar multiplication by k₂. This only requires computing the number of bits of k₁ or k₂.

For example, when a point on the elliptic curve of an elliptic curve cipher parameter is P, the scalar multiplication becomes KP=k₁·P+k₂·λP. When P+λP=S is given, if a bit value of a given digit is k₁=1, k₂=0, then P is used for computation. If k₁=0, k₂=1, then λP is used for computation. If k₁=1, k₂=1, then S is used for computation. If k₁=0, k₂=0, then no computation is required. Therefore, P, λP, or S is used for each digit for computation. In addition, this results in computing only the number of bits of k₁ or k₂. For example, if the scalar K has an equal number of bits to the number of bits of an order n of an elliptic curve rational point group, the number of bits of k₁ and k₂ becomes small as a number almost adjacent to √n. That is to say that the number of operations is thus reduced, and the operation speed can be speeded up.

Based on the above discussion, a configuration of an elliptic curve encryption processor of this embodiment will be discussed with reference to FIG. 1.

An elliptic curve encryption processor is provided with an input section 2 that inputs information indicating an elliptic curve E, a point P on the elliptic curve E, and an operation value K, and stores the information, the point P, and the operation value K in a memory section 1. The elliptic curve encryption processor is also provided with an embedding operation section 3 that retrieves the point P on the elliptic curve E stored in the memory section, maps the point P on the elliptic curve E to a Jacobi variety of an algebraic curve corresponding to the elliptic curve E, thereby obtaining a point on the Jacobi variety of the algebraic curve corresponding to the point P on the elliptic curve E as an embedding point D, and stores the embedding point D in the memory section 1. The elliptic curve encryption processor is also provided with a homomorphic processing section 4 that retrieves the embedding point D stored in the memory section 1, maps the embedding point D using a homomorphism on the Jacobi variety of the algebraic curve, thereby obtaining a mapping point εD, and stores the mapping point εD in the memory section 1. The elliptic curve encryption processor is also provided with a projection operation section 5 that retrieves the mapping point εD stored in the memory section 1, maps the mapping point εD onto the elliptic curve E, thereby obtaining a projection point P′ on the elliptic curve, and stores the projection point P′ in the memory section 1. The elliptic curve encryption processor is also provided with a computing section 6 that retrieves the operation value K and the projection point P′ that are stored in the memory section 1, performs a computation using the operation value K and the projection point P′, and stores a computation result in the memory section 1.

The elliptic curve encryption processor is further provided with a default setting section 7 that selects the algebraic curve and sets the algebraic curve in the memory section 1, and also sets a parameter for mapping the point P on the elliptic curve E to the Jacobi variety of the algebraic curve in the memory section 1. In addition, the elliptic curve encryption processor is further provided with an output section 8 for outputting a result of scalar multiplication, and a Central Processing Unit (CPU) 9 for controlling the operations of scalar multiplication.

It should be noted here that an operation value K indicates the scalar multiple K. Likewise, the scalar multiple K may be referred to as the operation value K hereinafter. It should also be noted here that the hyperelliptic curve of genus 2 is used as the algebraic curve. The elliptic curve encryption processor of this embodiment performs a scalar multiplication by the scalar multiple K that is inputted through the input section 2, which uses an operation on the Jacobi variety of the hyperelliptic curve C of genus 2. In addition, the homomorphic processing section 4 of the elliptic curve encryption processor multiplies a point on the Jacobi variety of the hyperelliptic curve C of genus 2 by √2.

The memory section 1 stores each value used in the process of scalar multiplication by the elliptic curve encryption processor.

The input section 2 inputs the expression of the elliptic curve E and parameters for defining the expression. The input section 2 also inputs a point P(z, t) on the elliptic curve E and the scalar multiple K.

The input section 2 may input information indicating an elliptic curve having a 2-torsion point as information indicating the elliptic curve E. The input section 2 may otherwise input information that indicates a prime order elliptic curve whose order is a prime number as information indicating the elliptic curve E.

Here, the expression of the elliptic curve E to be inputted and the parameters to define the expression are determined as follows.

The elliptic curve E is defined by transforming an elliptic curve including a rational point of order 2 into an elliptic curve indicated by an expression (1) (see Non-Patent Document 4).

[Expression 1]

$${T}^{2} = \frac{Δ ( a + 1 )}{U} ( Z + 1 ) \times [ \begin{matrix}- 32 ( 4 ( U - 3 ) α + {U}^{2} - 2 U - 4 ) \\ ( {Z}^{2} - 6 Z + 1 ) + {( U - 2 )}^{2} \\ ( ( {U}^{2} - 12 ) α - 2 ( U + 2 ) ) W ( {Z}^{2} + 1 ) + \\ 2 ( \begin{matrix}( {U}^{4} - 4 {U}^{3} - 8 {U}^{2} - 16 U + 144 ) \\ α - 2 ( {U}^{3} + 6 {U}^{2} - 20 U - 24 )\end{matrix} ) \\ WZ\end{matrix} ] \qquad ( 1 )$$

With reference to this expression, T, α, and U are parameters that define the elliptic curve.

The elliptic curve expressed by the expression (1) has a 2-torsion point (−1, 0) for an arbitrary prime field.

The elliptic curve including the rational point of order 2 is a new elliptic curve T²=Z³+sZ²+sZ+1 which is defined when s=(7δ²+3aδ−a²+3b)/(δ²+aδ+b) of an elliptic curve T²−(Z−δ)(Z²+aZ+b) that is defined depending on elements δ, a, b of the finite field GF(q).

The values of U, α, Δ, and W are defined such that this new elliptic curve T²=Z³+sZ²+sZ+1 and the expression (1) agree. These U, α, Δ, and W are the parameters of the elliptic curve E. The expression (1) that is defined by these values becomes the elliptic curve E used by the elliptic curve encryption processor. Therefore, through the input section 2, the expression (1) as the expression of the elliptic curve and U, α, Δ, and W as the parameters of the expression (1) are inputted as the information indicating the elliptic curve E.

The default setting section 7 may select a hyperelliptic curve as an algebraic curve. For example, the default setting section 7 of the elliptic curve encryption processor may select the hyperelliptic curve C of genus 2 as an algebraic curve.

It should be noted that the default setting section 7 selects the hyperelliptic curve C of genus 2 as an algebraic curve here.

The embedding operation section 3 performs an embedding operation from the elliptic curve E to the Jacobi variety of the hyperelliptic curve C of genus 2. Specifically, the point P on the elliptic curve E is mapped to the Jacobi variety of the hyperelliptic curve C of genus 2 corresponding to the elliptic curve E, thereby obtaining a point on the Jacobi variety of the hyperelliptic curve C of genus 2 corresponding to the point P on the elliptic curve E as an embedding point D.

The homomorphic processing section 4 maps the embedding point D using the homomorphism on the Jacobi variety of the hyperelliptic curve C of genus 2,thereby obtaining the mapping point εD.

The projection operation section 5 performs a mapping from the Jacobi variety of the hyperelliptic curve C of genus 2 to the elliptic curve. Specifically, the mapping point εD is mapped to the elliptic curve E, thereby obtain the projection point P′ on the elliptic curve.

The computing section 6 performs scalar multiplication using the GLV scalar multiplication based on the scalar multiple K and the projection point P′.

An operation of scalar multiplication performed by the elliptic curve encryption processor will now be discussed.

A processing method of a processor, using an elliptic curve, includes the following: inputting information indicating an elliptic curve E, a point P on the elliptic curve E, and an operation value K, and storing the information, the point P, and the operation value K in a memory section 1; retrieving the point P on the elliptic curve E stored in the memory section 1, mapping the point P on the elliptic curve E onto a Jacobi variety of an algebraic curve corresponding to the elliptic curve E and thereby obtaining a point on the Jacobi variety of the algebraic curve corresponding to the point P on the elliptic curve E as an embedding point D, and storing the embedding point D in the memory section 1; retrieving the embedding point D stored in the memory section 1, mapping the embedding point D using a homomorphism on the Jacobi variety of the algebraic curve and thereby obtaining a mapping point εD, and storing the mapping point εD in the memory section 1; retrieving the mapping point εD stored in the memory section 1, mapping the mapping point εD onto the elliptic curve E and thereby obtaining a projection point P′ on the elliptic curve E, and storing the projection point P′ in the memory section 1; and retrieving the operation value K and the projection point P′ stored in the memory section 1, performing a computation using the operation value K and the projection point P′, and storing a computation result in the memory section 1.

An operation of scalar multiplication performed by the elliptic curve encryption processor is discussed with reference to a flowchart shown in FIG. 2.

The input section 2 sets the expression of the elliptic curve E, first. Then the input section 2 inputs the parameters U, α, Δ, and W of the expression. The input section 2 also inputs the point P(z, t) on the elliptic curve E and the scalar multiple K. The expression of the elliptic curve E, the parameters U, α, Δ, and W, the point P(z, t) on the elliptic curve E, and the scalar multiple K inputted are stored in the memory section 1 (Step S100).

The default setting section 7 retrieves the elliptic curve E from the memory section 1, and performs an embedding operation of the elliptic curve E into the Jacobi variety of the hyperelliptic curve C of genus 2 that is defined by an expression (2) described below.

[Expression 2]

$${Y}^{2} = Δ ( {X}^{2} + UX + 2 ) ( {X}^{2} - {α}_{1} X - \frac{( U α + 4 )}{2} ) ( {X}^{2} - {α}_{2} X - \frac{( U α + 4 )}{2} ) \qquad ( 2 )$$

With reference to this expression, α₁, α₂ are the two roots of X²+((W(U−2)(U+2)+32)/(4U))X+W=0 as a quadratic equation of X. Also, T, α, and U are parameters that define the elliptic curve, and X and Y are variables.

The elliptic curve E is embedded into the Jacobi variety of the hyperelliptic curve C of genus 2 by the default setting section 7 setting a parameter for mapping the elliptic curve E to the Jacobi variety of the hyperelliptic curve C of genus 2. These parameters, once being set in the elliptic curve encryption processor, do not have to be reset every time an operation is performed unless the elliptic curve E to be used is changed. Thus, the parameters can be used continuously, and therefore the Step S101 can be omitted from the next time.

Then, the embedding operation section 3 performs an operation for mapping (the embedding operation) the point P=(z, t) on the elliptic curve E to the point D on the Jacobi variety of the hyperelliptic curve C of genus 2 (Step S102).

Here, the embedding operation section 3 performs a mapping onto the Jacobi variety of the algebraic curve, in which the elliptic curve E is embedded. The mapping is determined by the relational expressions of an expression (3) and an expression (4) for obtaining the embedding point D(x, y) on the Jacobi variety of the algebraic curve based on the point P=(z, t) on the elliptic curve E.

[Expression 3]

$$z = \frac{x - α - 1}{α x + α - 1} \qquad ( 3 )$$

[Expression 4]

$$t = \frac{32 y ( {U}^{3} - 8 {U}^{2} + 4 U + 32 + α ( U - 4 ) ( {U}^{2} + 4 U - 20 ) )}{{( ( U - 2 ) ( α x + α - 1 ) )}^{3}} \qquad ( 4 )$$

With reference to these expressions, x is the x-coordinate of the Jacobi variety of the hyperelliptic curve C of genus 2, and y is the y-coordinate of the Jacobi variety of the hyperelliptic curve C of genus 2. Then, z is the x-coordinate of the point P on the elliptic curve E, and t is the y-coordinate of the point P on the elliptic curve E. Then, α and U are parameters that define the elliptic curve E.

An operation of the embedding operation section 3 will be discussed with reference to a flowchart shown in FIG. 3.

The embedding operation section 3 retrieves the point P=(z, t) on the elliptic curve E from the memory section 1 (Step S300). Then, the embedding operation section 3 maps the point D=(x, y)−(x, −y) on the Jacobi variety of the hyperelliptic curve of genus 2 to a point on a product E×E of the elliptic curve when a square root in the finite field GF(q) of z as the x-coordinate of the point P on the elliptic curve E is r, and the point on the product E×E of the elliptic curve is (2(r², t), 2(1/r², t/r³)) (Step S301). Now, x, y are defined by an expression (5) and an expression (6).

[Expression 5]

$$x = \frac{( α - 1 ) z + α + 1}{- α z + 1} \qquad ( 5 )$$

[Expression 6]

$$y = \frac{{t ( ( U - 2 ) ( α x + α - 1 ) )}^{3}}{32 ( {U}^{3} - 8 {U}^{2} + 4 U + 32 + α ( U - 4 ) ( {U}^{2} + 4 U - 20 ) )} \qquad ( 6 )$$

With reference to these expressions, a and U are parameters that define the elliptic curve E.

The point D=(x, y)−(x, −y) is thus expressed as a pair of a quadratic polynomial U(x) and a linear polynomial V(x). The pair of U(x) and V(x) is stored in the memory section 1 (Step S302).

As mentioned, the operations of the Step S300 to the Step S302 are performed by the embedding operation section 3.

The discussion continues on the operation of scalar multiplication performed by the elliptic curve encryption processor with reference back to FIG. 2.

Subsequently, the homomorphic processing section 4 multiplies the point D on the Jacobi variety of the hyperelliptic curve of genus 2 as the algebraic curve by √2, thereby obtaining the mapping point εD.

More specifically, the homomorphic processing section 4 uses the hyperelliptic curve C of genus 2 as the algebraic curve, and multiplies the point D on the Jacobi variety of the hyperelliptic curve C of genus 2 by √2, thereby obtaining the mapping point εD (Step S103).

The homomorphic processing section 4 uses an endomorphism on the Jacobi variety of the algebraic curve as the homomorphism on the Jacobi variety of the algebraic curve. The endomorphism on the Jacobi variety of the algebraic curve is defined by a composition of a homomorphism from the Jacobi variety of the algebraic curve to the Jacobi variety of a Richelot dual curve of the algebraic curve and a homomorphism from the Jacobi variety of the Richelot dual curve of the algebraic curve to the Jacobi variety of the algebraic curve.

The former homomorphism from the Jacobi variety of the algebraic curve to the Jacobi variety of the Richelot dual curve of the algebraic curve is defined by an expression (7) and an expression (8) when the algebraic curve is the hyperelliptic curve C of genus 2.
G₁(x)H₁(z)+G₂(x)H₂(z)=0 (7)
ytₖ=ΔG₁(x)H₁(zₖ)(x−zₖ) (8)
With reference to these expressions, k=1, 2.

With further reference to these expressions, x is the x-coordinate of a point on the Jacobi variety of the hyperelliptic curve C of genus 2, y is the y-coordinate of the point on the Jacobi variety of the hyperelliptic curve C of genus 2, and z is the x-coordinate of a point on the Jacobi variety of the algebraic curve. Then, G1 and G2 are functions that define the hyperelliptic curve C of genus 2, and H1 and H2 are functions that define the Richelot dual curve of the hyper elliptic curve C of genus 2. Then zₖ is a zero point of the expression (1) about z, tₖ is a value that is defined by the expression (2) for each zₖ, and ΔG1 is a function that defines tₖ.

Then, the latter homomorphism from the Jacobi variety of the Richelot dual curve of the algebraic curve to the Jacobi variety of the algebraic curve is defined by an expression (9) when the algebraic curve is the hyperelliptic curve C of genus 2.
(x, y)→(2/x, (4y)/x³) (9)

With reference to this expression, x is the x-ordinate of a point on the Jacobi variety of the hyperelliptic curve C of genus 2, y is the y-coordinate of the point on the Jacobi variety of the hyperelliptic curve C of genus 2, and → is a sign that indicates mapping.

A description will be given in detail of a homomorphism that is used in the homomorphic processing section 4.

When the hyperelliptic curve C of genus 2 is expressed by Y²=ΔG₀(X)G₁(X)G₂(X), which is a product of a quadratic expression, and then Gᵢ(X)=ΣgᵢⱼX^{j}(i=0, 1,2), the Richelot dual curve of the hyperelliptic curve C of genus 2 is defined by an expression (10).
det(gᵢⱼ)T²=ΔH₀(Z)H₁(Z)H₂(Z) (10)

With reference to this expression, Hᵢ(Z)=G′ᵢ₊₁(Z)Gᵢ₊₂(Z)−G′ᵢ₊₂(Z)Gᵢ₊₁(Z), where G′ indicates a polynomial that is obtained by differentiating a polynomial G by Z.

Given this expression, the homomorphism p from the Jacobi variety of the hyperelliptic curve C of genus 2 to the Jacobi variety of the Richelot dual curve of the hyperelliptic curve C of genus 2 is defined as an expression (11).
[(x, y)−P₀]→[(z₁, t₁)−(z₂, −t₂)] (11)

With reference to this expression, P₀ is a point on the hyperelliptic curve C of genus 2 whose x-coordinate is a zero point of G₀ and y-coordinate is 0. Then, zₖ(k=1,2) is a zero point of a quadratic polynomial that is expressed by an expression (12) about z.
G₁(x)H₁(z)+G₂(x)H₂(z) (12)

For each zₖ, tₖ is defined by tₖ=(ΔG₁(x)H₁(zₖ)(x−zₖ))/y.

The former homomorphism from the Jacobi variety of the hyperelliptic curve C of genus 2 to the Jacobi variety of the Richelot dual curve of the hyperelliptic curve C of genus 2 may thus be described.

With further reference to the above description, the √2 multiplication based mapping ε of the hyperelliptic curve C of genus 2 is given by ±τ⁻¹ρ, where τ is the isomorphism from the hyperelliptic curve C of genus 2 to the Richelot dual curve of the hyperelliptic curve C of genus 2 that is defined by the expression (9). Then, τ⁻¹ is the latter homomorphism from the Jacobi variety of the Richelot dual curve of the hyperelliptic curve C of genus 2 to the Jacobi variety of the hyperelliptic curve C of genus 2.

An operation of the homomorphic processing section 4 will be discussed with reference to a flowchart shown in FIG. 4.

The homomorphic processing section 4 retrieves the pair of U(x) and V(x) generated by the embedding operation section 3 from the memory section 1 as the point D=(x, y)−(x′, y) of a degree zero divisor on the hyperelliptic curve C of genus 2 (Step S200).

Then, the homomorphic processing section 4 determines tₖ in tₖ=ΔG₁(x)H₁(zₖ)(x−zₖ) for zₖ(k=1,2) that satisfies G₁(x)H₁(z)+G₂(x)H₂(z)=0 based on (x, y). Likewise, the homomorphic processing section 4 determines t′ₖ in t′ₖ=ΔG₁(x)H₁(zₖ)(x−zₖ) for z′ₖ(k=1,2) that satisfies G₁(x)H₁(z)+G₂(x)H₂(z)=0 based on (x′, y) (Step S201).

Then, the homomorphic processing section 4 computes a quadratic polynomial U₀(z) and a linear polynomial V₀(z) that express a degree zero divisor, ((z₁, t₁)+(z₂, t₂))+((z′₁, t′₁)+(z′₂, t′₂)) (Step S202). This becomes a divisor on the Richelot dual curve.

Then, the homomorphic processing section 4 transforms U₀(z) and V₀(z) to U(z) and V(z) by a mapping between the Jacobi varieties that is determined by the mapping from the Richelot dual curve to C, (x, y)→(2/x, (4y)/x³) (Steps S203). The homomorphic processing section 4 then stores U(z) and V(z) in the memory section 1 (Step S204).

As mentioned, the operations of the Step S200 to the Step S204 are performed by the homomorphic processing section 4.

The discussion continues on the operation of scalar multiplication performed by the elliptic curve encryption processor with reference back to FIG. 2.

Subsequently, the projection operation section 5 performs an operation for mapping (the projection operation) the point εD=(x, y)−(x′, y) on the Jacobi variety of the hyperelliptic curve C of genus 2 to the point P′ on the elliptic curve (Step S104).

The projection operation section 5 performs a mapping onto the elliptic curve E that is determined by the relational expressions of an expression (13) and an expression (14) for obtaining the projection point P′(z, t) on the elliptic curve E based on the projection point εD=(x, y)−(x′, y′).

[Expression 7]

$$z = \frac{x - α - 1}{α x + α - 1} \qquad ( 13 )$$

[Expression 8]

$$t = \frac{32 y ( {U}^{3} - 8 {U}^{2} + 4 U + 32 + α ( U - 4 ) ( {U}^{2} + 4 U - 20 ) )}{{( ( U - 2 ) ( α x + α - 1 ) )}^{3}} \qquad ( 14 )$$

With reference to these expressions, x is the x-coordinate of a point on the Jacobi variety of the hyperelliptic curve C of genus 2, and y is the y-coordinate of the point on the Jacobi variety of the hyperelliptic curve C of genus 2. Then, z is the x-coordinate of the point P on the elliptic curve E and t is the y-coordinate of the point P on the elliptic curve E. Then, a and U are parameters that define the elliptic curve E.

Likewise, the projection operation section 5 defines z′ and t′ based on the following relational expressions of an expression (15) and an expression (16).

[Expression 9]

$${z}^{′} = \frac{{x}^{′} - α - 1}{α {x}^{′} + α - 1} \qquad ( 15 )$$

[Expression 10]

$${t}^{′} = \frac{32 {y}^{′} ( {U}^{3} - 8 {U}^{2} + 4 U + 32 + α ( U - 4 ) ( {U}^{2} + 4 U - 20 ) )}{{( ( U - 2 ) ( α {x}^{′} + α - 1 ) )}^{3}} \qquad ( 16 )$$

With reference to these expressions, x′ is the x-coordinate of a point on the Jacobi variety of the hyperelliptic curve C of genus 2, and y′ is the y-coordinate of the point on the Jacobi variety of the hyperelliptic curve C of genus 2. Then, z′ is the x-coordinate of the point P on the elliptic curve E, and t′ is the y-coordinate of the point P on the elliptic curve E. Then, α and U are parameters that define the elliptic curve E.

Then, the point P′ on the elliptic curve E that is given by (z², t)−(z′², t′) is mapped.

An operation performed by the projection operation section 5 will be discussed with reference to a flowchart shown in FIG. 5.

The projection operation section 5 retrieves U(z) and V(z) generated by the homomorphic processing section 4 from the memory section 1 as the point (x, y)−(x′, y′) on the Jacobi variety of the hyperelliptic curve C of genus 2 (Step S400).

Then, the projection operation section 5 obtains z, t, z′, and t′ based on the expressions (14) to (17), so that the point P′ on the elliptic curve E that is given by (z², t)−(z′², t′) is obtained (Step S401).

Then, the projection operation section 5 stores the point P′ on the elliptic curve obtained in the memory section 1 (Step S402).

As mentioned, the operations of the Step S400 to the Step S402 are performed by the projection operation section 5.

The discussion continues on the operation of scalar multiplication performed by the elliptic curve encryption processor with reference back to FIG. 2.

The computing section 6, after performing the operations of the Step S100 to the Step 104, retrieves the point P′ on the elliptic curve E from the memory section 1. Then, the computing section 6 performs an operation of scalar multiplication of the point P′ on the elliptic curve E by the scalar multiple K using the previously discussed GLV scalar multiplication, thereby obtaining KP′ (Step S105). Then, the computing section 6 outputs the KP′ as a computation result (Step S106).

Here is the summary of the method of the above described scalar multiplication performed by the elliptic curve encryption processor according to this embodiment. Firstly, the point P on the elliptic curve E is transformed into the point D on the Jacobi variety of the hyperelliptic curve C of genus 2 by the embedding operation section 3. Then, εD is obtained through computation using the √2 multiplication mapping ε by the homomorphic processing section 4. Then, the point on the elliptic curve E is obtained based on εD by the projection operation section 5, where that particular point is referred to as φ(P). Lastly, the GLV scalar multiplication is performed by using φ(P) as the special homomorphism. Thus, the scalar multiplication by the scalar multiple K may be achieved.

The above described scalar multiplication may be implemented on a computer if the method of the scalar multiplication is written in a program.

Specifically, a program for causing a computer to execute the scalar multiplication (by K) of the point P on the elliptic curve E may include: transforming the point P on the elliptic curve E to the point D on the Jacobi variety of the hyperelliptic curve C of genus 2, mapping the point D by the homomorphism on the Jacobi variety of the hyperelliptic curve C of genus 2 and thereby obtaining the mapping point εD, mapping the mapping point ED onto the elliptic curve E and thereby obtaining the projection point P′ on the elliptic curve, retrieving the operational value K and the projection point P′, multiplying the projection point P′ by K, and outputting a computation result.

According to this embodiment, the elliptic curve encryption processor is provided with the input section that inputs the information indicating the elliptic curve E, the point P on the elliptic curve E, and the operation value K, and stores the information, the point P, and the operation value K in the memory section; the embedding operation section that retrieves the point P on the elliptic curve E stored in the memory section, maps the point P on the elliptic curve E to the Jacobi variety of the algebraic curve corresponding to the elliptic curve E, thereby obtaining the point on the Jacobi variety of the algebraic curve corresponding to the point P on the elliptic curve E as the embedding point D, and stores the embedding point D in the memory section; the homomorphic processing section that retrieves the embedding point D stored in the memory section, maps the embedding point D using the homomorphism on the Jacobi variety of the algebraic curve, thereby obtaining the mapping point εD, and stores the mapping point εD in the memory section; the projection operation section that retrieves the mapping point εD stored in the memory section, maps the mapping point εD onto the elliptic curve E, thereby obtaining the projection point P′ on the elliptic curve, and stores the projection point P′ in the memory section; and the computing section that retrieves the operation value K and the projection point P′ that are stored in the memory section, performs a computation using the operation value K and the projection point P′, and stores the computation result in the memory section. Hence, a faster computation of scalar multiplication in elliptic curve cryptography is allowed.

According to this embodiment, the elliptic curve encryption processor is further provided with the default setting section that selects the algebraic curve and sets the algebraic curve in the memory section, and also sets the parameter for mapping the point P on the elliptic curve E to the Jacobi variety of the algebraic curve in the memory section. Hence, the elliptic curves to be used may be changed, which allows elliptic curve cryptography to be performed with a variety of elliptic curves. As a result, an enhanced security may be achieved in elliptic curve cryptography when performed by the elliptic curve encryption processor.

According to this embodiment, the default setting section of the elliptic curve encryption processor selects the hyperelliptic curve as the algebraic curve, and further selects the hyperelliptic curve C of genus 2 as the algebraic curve. Hence, a faster computation of scalar multiplication in elliptic curve cryptography is allowed by mapping the point P on the elliptic curve E to the Jacobi variety of the hyperelliptic curve C of genus 2.

According to this embodiment, the homomorphic processing section of the elliptic curve encryption processor multiplies the point D on the Jacobi variety of the algebraic curve by √2, thereby obtaining the mapping point εD. Hence, it becomes possible to use the efficiently computable homomorphism of √2 multiplication mapping.

According to this embodiment, the input section of the elliptic curve encryption processor inputs the information indicating the elliptic curve with the 2-torsion point as the information indicating the elliptic curve E or inputs the information indicating the prime order elliptic curve whose order is a prime number as the information indicating the elliptic curve E. Hence, a faster computation of scalar multiplication in elliptic curve cryptography is allowed using the mapping of the point P on the elliptic curve E to the Jacobi variety of the hyperelliptic curve C of genus 2.

According to this embodiment, the homomorphic processing section of the elliptic curve encryption processor uses the endomorphism on the Jacobi variety of the algebraic curve as the homomorphism on the Jacobi variety of the algebraic curve, the endomorphism being determined by the composition of the homomorphism from the Jacobi variety of the algebraic curve to the Jacobi variety of the Richelot dual curve of the algebraic curve and the homomorphism from the Jacobi variety of the Richelot dual curve of the algebraic curve to the Jacobi variety of the algebraic curve. Hence, this endomorphism on the Jacobi variety of the algebraic curve may be used as the homomorphism by which scalar multiplication is efficiently computable.

According to this embodiment, the homomorphism from the Jacobi variety of the algebraic curve to the Jacobi variety of the Richelot dual curve of the algebraic curve, which is used in the homomorphism processing section of the elliptic curve encryption processor, is defined by: the expression (7) and the expression (8) when the algebraic curve is the hyperelliptic curve C of genus 2. And, the homomorphism from the Jacobi variety of the Richelot dual curve of the algebraic curve to the Jacobi variety of the algebraic curve, which is used in the homomorphism processing section of the elliptic curve encryption processor, is defined by the expression (9) when the algebraic curve is the hyperelliptic curve C of genus 2. Hence, the endomorphism on the Jacobi variety of the algebraic curve as the composition of these homomorphisms may be used as the homomorphism by which scalar multiplication is efficiently computable.

According to this embodiment, the embedding operation section of the elliptic curve encryption processor performs the mapping onto the Jacobi variety of the algebraic curve, in which the elliptic curve E is embedded, for obtaining the embedding point D (x, y) on the Jacobi variety of the algebraic curve based on the point P(z, t) on the elliptic curve E, and the mapping is determined by the relational expressions of the expression (39 and the expression (4). Hence, the point P on the elliptic curve E may be mapped to the point D on the Jacobi variety of the algebraic curve.

According to this embodiment, the projection operation section of the elliptic curve encryption processor performs the mapping onto the elliptic curve E for obtaining the projection point P′(z, t) based on the point εD(x, y), and the mapping is determined by the relational expressions of the expression (13) and the expression (16). Hence, the projection point εD on the Jacobi variety of the algebraic curve may be mapped to the point P′ on the elliptic curve E.

According to this embodiment, the processing method of the processor, using the elliptic curve, includes inputting information indicating the elliptic curve E, the point P on the elliptic curve E, and the operation value K, and storing the information, the point P, and the operation value K in the memory section; retrieving the point P on the elliptic curve E stored in the memory section, mapping the point P on the elliptic curve E onto the Jacobi variety of the algebraic curve corresponding to the elliptic curve E and thereby obtaining the point on the Jacobi variety of the algebraic curve corresponding to the point P on the elliptic curve E as the embedding point D, and storing the embedding point D in the memory section; retrieving the embedding point D stored in the memory section, mapping the embedding point D using the homomorphism on the Jacobi variety of the algebraic curve and thereby obtaining the mapping point εD, and storing the mapping point εD in the memory section; retrieving the mapping point εD stored in the memory section, mapping the mapping point εD onto the elliptic curve E and thereby obtaining the projection point P′ on the elliptic curve E, and storing the projection point P′ in the memory section; and retrieving the operation value K and the projection point P′ stored in the memory section, performing the computation using the operation value K and the projection point P′, and storing the computation result in the memory section. Hence, a faster computation of scalar multiplication in elliptic curve cryptography is allowed.

According to this embodiment, the program includes the processing of transforming the point P on the elliptic curve E to a point D on a Jacobi variety of a hyperelliptic curve C of genus 2; mapping the point D using a homomorphism on the Jacobi variety of the hyperelliptic curve of genus 2 and thereby obtaining a mapping point εD; mapping the mapping point εD onto the elliptic curve E and thereby obtaining a projecting point P′ on the elliptic curve; and retrieving an operation value K and the projection point P′, multiplying the projection point P′ by K, and outputting a computation result. Hence, scalar multiplication (by K) of the point P on the elliptic curve E may be executed on a computer,

Conventionally, the GLV scalar multiplication as an acceleration technique of scalar multiplication in elliptic curve cryptography is only applicable to very special types of elliptic curves E. This embodiment, however, allows the GLV scalar multiplication to be applicable to more general types of elliptic curves E. Hence, this application makes a great contribution to elliptic curve cryptography in terms of security, fully guaranteed in practice.

The embodiment is thus described.

It should be noted that the elliptic curve encryption processor is characterized by including: the operation section that embeds the elliptic curve into the Jacobi variety of the hyperelliptic curve C of genus 2; the operation section that maps the point on the elliptic curve to the point on the Jacobi variety of the hyperelliptic curve C of genus 2 (the embedding operation); the operation section that multiplies the point on the Jacobi variety of the hyperelliptic curve C of genus 2 by √2; and the operation section that maps the point on the Jacobi variety of the hyperelliptic curve C of genus 2 to the point on the elliptic curve (the projection operation). It is to be noted that the √2 multiplication is the operation that obtains 2 multiplication mapping when it is performed twice, which is described in Non-Patent Document 4.

It should also be noted that the elliptic curve encryption processor is characterized by using the endomorphism on the Jacobi variety of the hyperelliptic curve C of genus 2 as the special homomorphism φ. The endomorphism is defined by the composition of the homomorphism from the Jacobi variety of C to the Jacobi variety of the Richelot dual curve of C that is determined by the following expression,
G₁(x)H₁(z)+G₂(x)H₂(z)=0, ytₖ=ΔG₁(x)H₁(zₖ)(x−zₖ),
and the homomorphism from the Jacobi variety of the Richelot dual curve of C to the Jacobi variety of C that is determined by the following expression,
(x, y)→(2/x, (4y)/x³).

The elliptic curve encryption processor is characterized in that the mapping from the elliptic curve E to the Jacobi variety of the hyperelliptic curve C of genus 2 and the mapping from the Jacobi variety of the hyper elliptic curve C of genus 2 to the elliptic curve E are defined by the following relational expressions between the point (z, t) on the elliptic curve and the point (x, y) on the hyperelliptic curve C of genus 2.
z=(x−α−1)/(αx+α−1)
t=32y(U³−8U²+4U+32+α(U−4)(U²+4U−20))/((U−2)(αx+α−1))³

In addition, a program may be used to cause a computer to execute an operation using the operation sections of the elliptic curve encryption processor: the operation section that embeds the elliptic curve into the Jacobi variety of the hyperelliptic curve C of genus 2; the operation section that maps the point on the elliptic curve to the point on the Jacobi variety of the hyperelliptic curve C of genus 2 (the embedding operation); the operation section that multiplies the point on the Jacobi variety of the hyperelliptic curve C of genus 2 by √2; and the operation section that maps the point on the Jacobi variety of the hyperelliptic curve C of genus 2 to the point on the elliptic curve (the projection operation). It should be noted that the √2 multiplication is the operation that obtains 2 multiplication mapping when it is performed twice, which is described in Non-Patent Document 4.

In addition, a program may be used to cause a computer to execute an operation of the elliptic curve encryption processor using the endomorphism on the Jacobi variety of the hyperelliptic curve C of genus 2 as the special homomorphism φ. The endomorphism is defined by the composition of the homomorphism from the Jacobi variety of C to the Jacobi variety of the Richelot dual curve of C that is determined by the following expression,
G₁(x)H₁(z)+G₂(x)H₂(z)=0, ytₖ=ΔG₁(x)H₁(zₖ)(x−zₖ),
and the homomorphism from the Jacobi variety of the Richelot dual curve of C to the Jacobi variety of C that is determined by the following expression,
(x, y)→(2/x, (4y)/x³).

In addition, a program may be used to cause a computer to execute an operation of the elliptic curve encryption processor using the mapping from the elliptic curve E to the Jacobi variety of the hyperelliptic curve C of genus 2 and the mapping from the Jacobi variety of the hyper elliptic curve C of genus 2 to the elliptic curve E, which are defined by the following relational expressions between the point (z, t) on the elliptic curve and the point (x, y) on the hyperelliptic curve C of genus 2.
z=(x−α−1)/(αx+α−1)
t=32y(U³−8U²+4U+32+α(U−4)(U²+4U−20))/((U−2)(αx+α−1))³

The thus described elliptic curve encryption processor of this embodiment may be implemented on a computer. FIG. 6 is a diagram illustrating a hardware configuration of the elliptic curve encryption processor of this embodiment when implemented on a computer.

With reference to FIG. 6, the elliptic curve encryption processor is provided with a Central Processing Unit (CPU) 911 for executing a program. The CPU 911 is connected to a Read Only Memory (ROM) 913, a Random Access Memory (RAM) 914, a communication board 915, a display unit 901, a keyboard (k/B) 902, a mouse 903, a Flexible Disk Drive (FDD) 904, a magnetic disk drive 920, a Compact Disk Drive (CDD) 905, a printer unit 906, and a scanner unit 907 via a bus 912.

The RAM 914 is an example of volatile memory. The ROM 913, the FDD 904, the CDD 905, the magnetic disk drive 920, an optical disk drive are examples of nonvolatile memory. These are examples of memory unit or memory section.

The magnetic disk drive 920 stores an operating system (OS) 921, a window system 922, a program group 923, and a file group 924. The program group 923 is executed by the CPU 911, the OS 921, and the window system 922.

The program group 923 stores programs for executing the functions of the elements that were referred to hereinbefore as “sections” in the description of the embodiment. Programs are retrieved by the CPU 911 and executed.

Arrows in the flowcharts in the above description of the embodiment each mainly indicate the input/output of data. For data input/output, data may be recorded on any other storage medium, such as the magnetic disk drive 920, a Flexible Disk (FD), an optical disk, a Compact Disk (CD), a Mini Disk (MD), or a Digital Versatile Disk (DVD). Data is otherwise transmitted through any transmission medium, such as a signal line.

Any element that was referred to hereinbefore as a “section” in the description of the embodiment may be implemented by firmware that is stored in the ROM 913. The element may otherwise be implemented by software alone, a combination of software and hardware, or a combination of software, hardware and firmware.

The program for implementing the above discussed embodiment may be stored by using any other storage medium, such as the magnetic disk drive 920, the Flexible Disk (FD), the optical disk, the Compact Disk (CD), the Mini Disk (MD), or the Digital Versatile Disk (DVD).

### BRIEF DESCRIPTION OF THE DRAWINGS

FIG. 1 is a diagram illustrating a configuration of an elliptic curve encryption processor according to an embodiment;

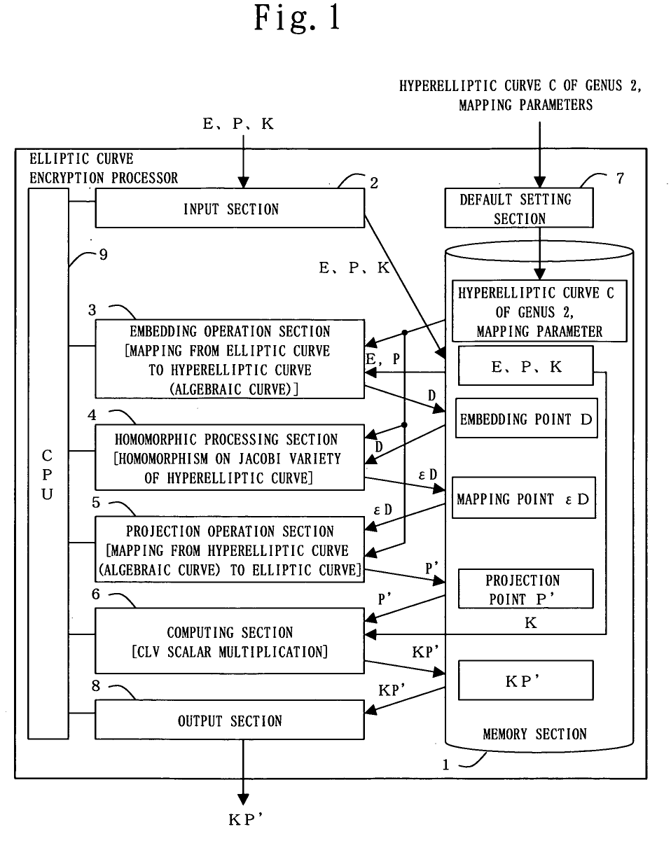

FIG. 2 is a flowchart illustrating an operation of scalar multiplication performed by the elliptic curve encryption processor according to the embodiment;

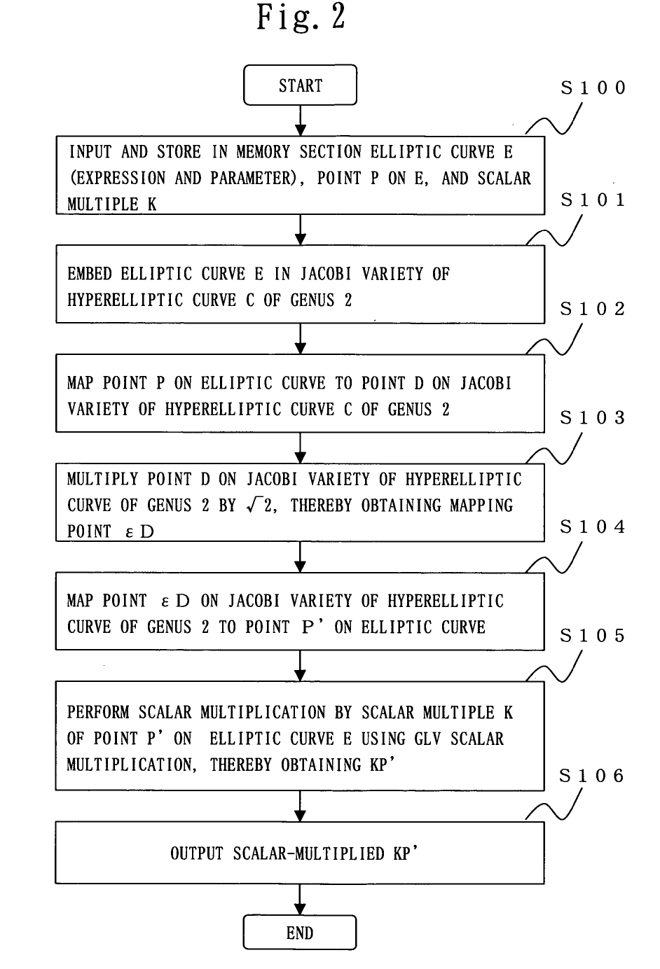

FIG. 3 is a flowchart illustrating an operation performed by an embedding operation section of the elliptic curve encryption processor according to the embodiment;

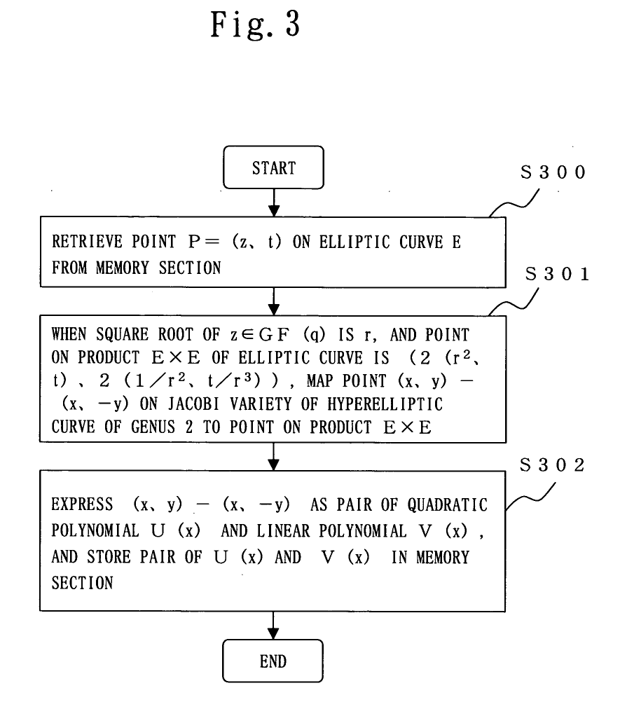

FIG. 4 is a flowchart illustrating an operation performed by a homomorphic processing section of the elliptic curve encryption processor according to the embodiment;

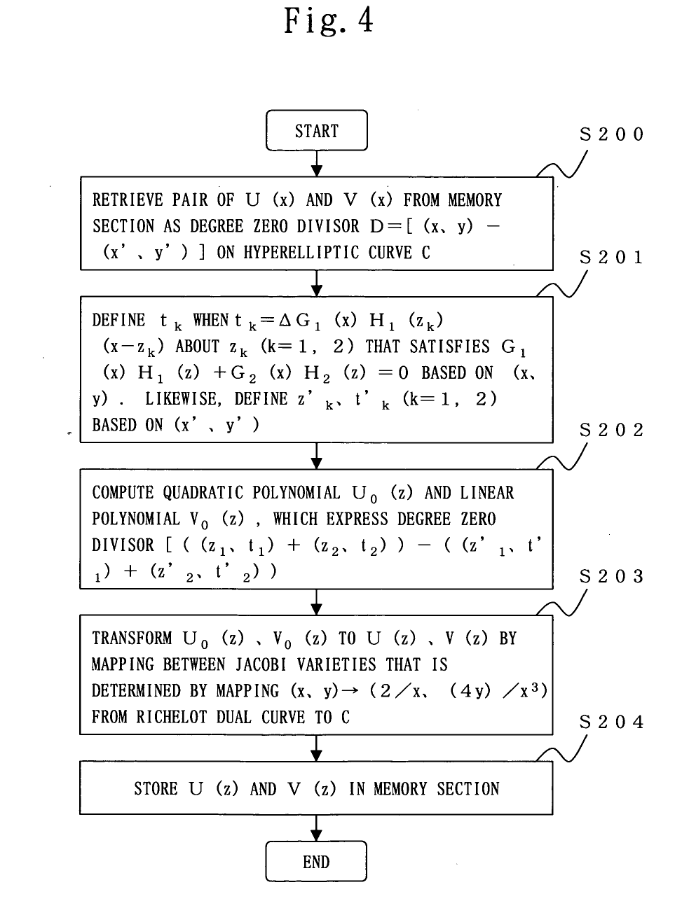

FIG. 5 is a flowchart illustrating an operation performed by a projection operation section of the elliptic curve encryption processor according to the embodiment; and

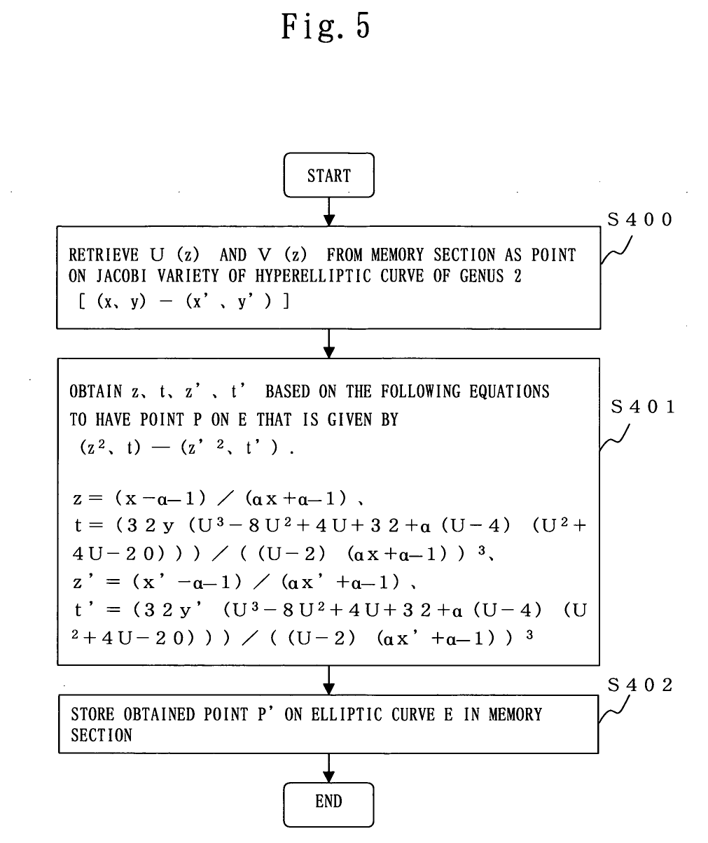

FIG. 6 is a diagram illustrating a hardware configuration of the elliptic curve encryption processor according to the embodiment in a computer implementation.

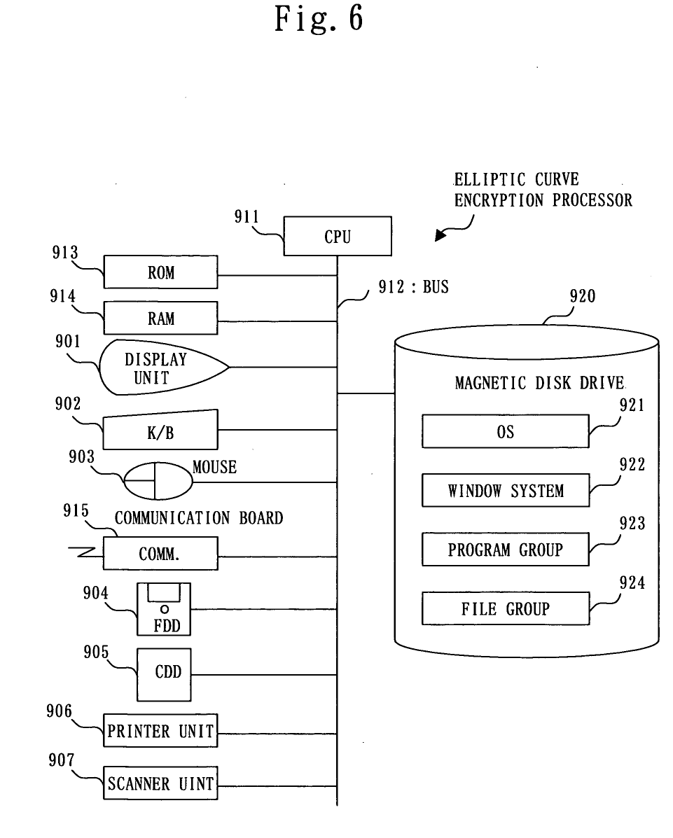

### EXPLANATION OF REFERENCE NUMERALS AND SIGNS

1 memory section
2 input section
3 embedding operation section
4 homomorphic processing section
5 projection operation section
6 computing section
7 default setting section
901 display unit
902 keyboard (K/B)
903 mouse
904 FDD
905 CDD
906 printer unit
907 scanner unit
911 CPU
912 bus
913 ROM
914 RAM
915 communication board
920 magnetic disk drive
921 OS
922 window system
923 program group
924 file group

1. An elliptic curve encryption processor, comprising:
an input section that inputs information indicating an elliptic curve E, a point P on the elliptic curve E, and an operation value K, and stores the information, the point P, and the operation value K in a memory section;
an embedding operation section that retrieves the point P on the elliptic curve E stored in the memory section, maps the point P on the elliptic curve E to a Jacobi variety of an algebraic curve corresponding to the elliptic curve E, thereby obtaining a point on the Jacobi variety of the algebraic curve corresponding to the point P on the elliptic curve E as an embedding point D, and stores the embedding point D in the memory section;
a homomorphic processing section that retrieves the embedding point D stored in the memory section, maps the embedding point D using a homomorphism on the Jacobi variety of the algebraic curve, thereby obtaining a mapping point εD, and stores the mapping point εD in the memory section;
a projection operation section that retrieves the mapping point εD stored in the memory section, maps the mapping point εD onto the elliptic curve E, thereby obtaining a projection point P′ on the elliptic curve, and stores the projection point P′ in the memory section; and
a computing section that retrieves the operation value K and the projection point P′ that are stored in the memory section, performs a computation using the operation value K and the projection point P′, and stores a computation result in the memory section.

2. The elliptic curve encryption processor of claim 1, further comprising:
a default setting section that selects the algebraic curve and sets the algebraic curve in the memory section, and also sets a parameter for mapping the point P on the elliptic curve E to the Jacobi variety of the algebraic curve in the memory section.

3. The elliptic curve encryption processor of claim 2, wherein the default setting section selects a hyperelliptic curve as the algebraic curve.

4. The elliptic curve encryption processor of claim 2, wherein the default setting section selects a hyperelliptic curve C of genus 2 as the algebraic curve.

5. The elliptic curve encryption processor of claim 1, wherein the homomorphic processing section multiplies the point D on the Jacobi variety of the algebraic curve by √2, thereby obtaining the mapping point εD.

6. The elliptic curve encryption processor of claim 1, wherein the input section inputs information indicating an elliptic curve with a 2-torsion point as the information indicating the elliptic curve E.

7. The elliptic curve encryption processor of claim 1, wherein the input section inputs information indicating a prime order elliptic curve whose order is a prime number as the information indicating the elliptic curve E.

8. The elliptic curve encryption processor of claim 1, wherein the homomorphic processing section uses an endomorphism on the Jacobi variety of the algebraic curve as the homomorphism on the Jacobi variety of the algebraic curve, the endomorphism being determined by a composition of a homomorphism from the Jacobi variety of the algebraic curve to the Jacobi variety of a Richelot dual curve of the algebraic curve and a homomorphism from the Jacobi variety of the Richelot dual curve of the algebraic curve to the Jacobi variety of the algebraic curve.

9. The elliptic curve encryption processor of claim 8, wherein the homomorphism from the Jacobi variety of the algebraic curve to the Jacobi variety of the Richelot dual curve of the algebraic curve is defined by:
G₁(x)H₁(z)+G₂(x)H₂(z)=0 (1)
ytₖ=ΔG₁(x)H₁(zₖ)(x−zₖ) (2)
where k=1, 2
when the algebraic curve is a hyperelliptic curve C of genus 2 (where x is an x-coordinate of a point on the Jacobi variety of the hyperelliptic curve of genus 2, y is a y-coordinate of the point on the Jacobi variety of the hyperelliptic curve C of genus 2, z is an x-coordinate of a point on the Jacobi variety of the algebraic curve, G1 and G2 are functions that define the hyperelliptic curve C of genus 2, H1 and H2 are functions that define the Richelot dual curve of the hyperelliptic curve of genus 2, zk is a zero point of the expression (1) about z, tₖ is a value of each zₖ that is defined by the expression (2), and ΔG1 is a function that defines tₖ).

10. The elliptic curve encryption processor of claim 8, wherein the homomorphism from the Jacobi variety of the Richelot dual curve of the algebraic curve to the Jacobi variety of the algebraic curve is defined by
(x, y)→(2/x, (4y)/x³)
when the algebraic curve is a hyperelliptic curve C of genus 2 (where x is an x-coordinate of a point on the Jacobi variety of the hyperelliptic curve C of genus 2, y is a y-coordinate of the point on the Jacobi variety of the hyperelliptic curve C of genus 2, and → is a sign indicating a mapping).

11. The elliptic curve encryption processor of claim 1, wherein the embedding operation section performs a mapping onto the Jacobi variety of the algebraic curve, in which the elliptic curve E is embedded, for obtaining the embedding point D (x, y) on the Jacobi variety of the algebraic curve based on the point P(z, t) on the elliptic curve E, the mapping determined by relational expressions:
$$\begin{matrix}z = \frac{x - α - 1}{α x + α - 1} & [ Expression 11 ] \\ t = \frac{32 y ( {U}^{3} - 8 {U}^{2} + 4 U + 32 + α ( U - 4 ) ( {U}^{2} + 4 U - 20 ) )}{{( ( U - 2 ) ( α x + α - 1 ) )}^{3}} & [ Expression 12 ]\end{matrix}$$
(where x is an x-coordinate of a point on the Jacobi variety of a hyperelliptic curve C of genus 2, y is a y-coordinate of the point on the Jacobi variety of the hyperelliptic curve C of genus 2, z is an x-coordinate of the point P on the elliptic curve E, t is a y-coordinate of the point P on the elliptic curve E, and a and U are parameters that define the elliptic curve E).

12. The elliptic curve encryption processor of claim 1, wherein the projection operation section performs a mapping onto the elliptic curve E for obtaining the projection point P′(z, t) based on the projection point εD(x, y), the mapping determined by relational expressions:
$$\begin{matrix}z = \frac{x - α - 1}{α x + α - 1} & [ Expression 13 ] \\ t = \frac{32 y ( {U}^{3} - 8 {U}^{2} + 4 U + 32 + α ( U - 4 ) ( {U}^{2} + 4 U - 20 ) )}{{( ( U - 2 ) ( α x + α - 1 ) )}^{3}} & [ Expression 14 ]\end{matrix}$$
(where x is an x-coordinate of a point on the Jacobi variety of a hyperelliptic curve C of genus 2, y is a y-coordinate of the point on the Jacobi variety of the hyperelliptic curve of genus 2, z is an x-coordinate of the point P on the elliptic curve E, t is a y-coordinate of the point P on the elliptic curve E, and α and U are parameters that define the elliptic curve E).

13. A processing method of a processor, using an elliptic curve, comprising:
inputting information indicating an elliptic curve E, a point P on the elliptic curve E, and an operation value K, and storing the information, the point P, and the operation value K in a memory section;
retrieving the point P on the elliptic curve E stored in the memory section, mapping the point P on the elliptic curve E onto a Jacobi variety of an algebraic curve corresponding to the elliptic curve E and thereby obtaining a point on the Jacobi variety of the algebraic curve corresponding to the point P on the elliptic curve E as an embedding point D, and storing the embedding point D in the memory section;
retrieving the embedding point D stored in the memory section, mapping the embedding point D using a homomorphism on the Jacobi variety of the algebraic curve and thereby obtaining a mapping point εD, and storing the mapping point εD in the memory section;
retrieving the mapping point εD stored in the memory section, mapping the mapping point ED onto the elliptic curve E and thereby obtaining a projection point P′ on the elliptic curve E, and storing the projection point P′ in the memory section; and
retrieving the operation value K and the projection point P′ stored in the memory section, performing a computation using the operation value K and the projection point P′, and storing a computation result in the memory section.

14. A program for causing a computer to execute scalar multiplication (by K) of a point P on an elliptic curve E, the program comprising:
transforming the point P on the elliptic curve E to a point D on a Jacobi variety of a hyperelliptic curve C of genus 2;
mapping the point D using a homomorphism on the Jacobi variety of the hyperelliptic curve of genus 2 and thereby obtaining a mapping point ED;
mapping the mapping point ED onto the elliptic curve E and thereby obtaining a projecting point P′ on the elliptic curve; and
retrieving an operation value K and the projection point P′, multiplying the projection point P′ by K, and outputting a computation result.
